(19) United States
(12) Patent Application Publication
(10) Pub. No.: US 2004/0121115 A1
(43) Pub. Date: Jun. 24, 2004

(54) Enhanced surface coverings, yarns and methods

(76) Inventors: James C. Bridges, LaGrange, GA (US); Wilson A. Latham, Alma, GA (US); David M. Lasseter, Alma, GA (US); David E. McCarty, Alma, GA (US); Carroll E. Deen, Nicholls, GA (US)

Correspondence Address: Milliken & Company, P. O. Box 1927, Spartanburg, SC, 29304, US

(21) Appl. No.: 10/327,724

(22) Filed: Dec. 23, 2002

(51) Int. Cl. B32B 33/00; B32B 3/02; D02G 3/02; D02G 3/04; D02G 3/28; D02G 3/40

(52) U.S. Cl. 428/97; 428/88; 428/96; 428/92; 57/238; 57/242; 57/251; 57/297

(57) ABSTRACT

A process for forming a carpet, and the carpet formed thereby are provided. The process includes forming a thread comprising low melt fiber and high melt fiber. The thread is then heated above a temperature sufficient to melt the low melt fiber. The thread is tufted in a carpet backing to form a tufted carpet. The tufted carpet is then printed or dyed with an image. A process for forming a low melt content yarn and the yarn formed thereby are provided. It is preferred that the carpet and low melt content yarn be adapted to printing or dyeing.

### BACKGROUND OF THE INVENTION

The present invention relates to a process for manufacturing an improved or enhanced surface covering such as a carpet and the carpet manufactured thereby. More specifically, the present invention relates to a process for forming a carpet wherein the carpet comprises a combination of fibers with one fiber being lower melting than the other fiber or fibers and printing or dyeing this carpet.

It has been known in the art to combine various yarns to form a composite yarn for carpet production. Examples of such teachings include U.S. Pat. No. 5,336,562, issued to Forero, wherein polyethylene filaments and polypropylene filaments are combined in a “parallelized” orientation. The parallel fibers are then heated to an excess of 120° C. to melt the polyethyelene filaments. Yarns such as these are dyed prior to incorporation into a carpet. Dyeing prior to carpet formation, weaving or tufting, is highly undesirable since inventory must be maintained for each fiber color. Furthermore, the ability to custom manufacture carpet and the selection of designs and patterns is severely hindered.

Other yarns have been used to manufacture carpet in either a colorless form or in a generic color. The carpet is then overcoat with a pattern, or color, by printing or dyeing, on demand. This process greatly decreases the items that must be maintained in inventory and thereby decreases manufacturing cost. A superior form of jet dyeing of carpet in a pixelated fashion has been achieved using a Millitron™ jet dye machine by Milliken & Company of Spartanburg, S.C. Techniques for printing carpet are known and exemplified in U.S. Pat. Nos. 3,894,413; 5,142,481 and 6,120,560 which are incorporated herein by reference thereto. While these methods have greatly increased the manufacturing efficiency, the pattern resolution is limited, in part, by carpet sueding. Carpet fibers have a tendency to bend or lay over. If the pile or yarns are not all oriented similarly, one section may appear to be a different shade than the surrounding area. While this is common in finished carpet the ability of a carpet to suede or for the pile to be oriented other than vertical greatly decreases the resolution of any image that can be printed or dyed on the carpet. If for example, two regions are sueded differently the dye will be partially applied to the side of the sueded fibers instead of at the tuft head, or top, of the fiber. Therefore, the limiting resolution of the printing process is determined, in part, by the ability of the carpet to suede, pile lay, pile orientation, etc.

Sueding can be eliminated, or mitigated, by increasing the brittleness of the carpet fibers. This is contrary to desires in the art since the more brittle carpet is considered to be deficient with respect to comfort factors typically desired in carpet. For example, a harder or more brittle carpet may not be viewed as soft or plush.

Yet another problem in the art is the inconsistency with which carpet fibers absorb dye. One approach to circumvent this deficiency is to utilize ever softer fibers which absorb dyes more readily. Softer fibers have a higher tendency to suede and therefore resolution is still limited.

There has been a long felt desire in the art for a carpet, and a process for preparing carpet, wherein the carpet can be printed or dyed to a high degree of definition, or high resolution, yet which still has the features associated with comfort.

### BRIEF SUMMARY OF THE INVENTION

It is an object of at least one embodiment of the present invention to provide a carpet, and process for manufacturing the carpet, which allows for high resolution printing or dyeing and that maintains high resolution after wear.

It is another object of at least one embodiment of the present invention to provide a carpet, and process for manufacturing the carpet, which has excellent wearability and a durable high resolution image.

A particular feature of at least one embodiment of the present invention is the ability to decrease inventory while still being able to provide carpet with a pattern that is selected on demand and wherein the pattern is a high resolution pattern that is durable and remains high resolution after wear.

These and other advantages are provided in selected process for forming a carpet, and the carpets formed thereby. A first process includes forming a thread or yarn comprising low melt fiber or filament and high melt fiber or filament. The thread is then heated (heat set) above a temperature sufficient to melt the low melt fiber. The thread is tufted in a carpet backing to form a tufted carpet. The tufted carpet is then printed or dyed with an image.

In accordance with another embodiment of a process for forming printed or dyed carpet, and the carpet formed thereby, the process comprises the steps of forming a blended fiber comprising at least one low melt fiber and at least one high melt fiber. A thread or yarn is formed of the blended fiber. The thread is heated above a temperature sufficient to melt the low melt fiber. The thread is tufted in a carpet backing to form a tufted carpet. Then, an image is printed or dyed on the tufted carpet.

In yet another embodiment of a process for forming printed carpet, and the carpet formed thereby, the process comprises the steps of forming a thread or yarn from at least one high melt fiber. The thread is passed through a doubling or winding process wherein at least one low melt fiber is incorporated into the thread. The combined thread is heated above a temperature sufficient to melt the low melt fiber. The heated thread is tufted in a carpet backing to form a tufted carpet. Then, an image is printed or dyed on the tufted carpet.

In still yet another embodiment of a process for forming printed carpet, and the carpet formed thereby, the process comprises the steps of forming a thread from a high melt fiber, passing the thread through a ring spinning process wherein a low melt fiber is incorporated into the thread. Next, the thread is heated above a temperature sufficient to melt the low melt fiber. The thread is tufted in a carpet backing to form a tufted carpet. Then, an image or pattern is printed on the tufted carpet.

In accordance with the present invention, the addition of a “low melt” polyester or nylon (such as manufactured by Solutia) during the yarn manufacturing process (whether all one type of fiber or a blend of multi-types such as wool, nylon, a combination of these or others) results in a yarn after the heatset process that has enhanced end point definition and optical color evenness when put into a carpet base and dyed by a jet dye machine. Both stape and filament low-melts will work but the filament low-melt is preferred.

Even after extended wear tests, the carpet of the present invention shows less evidence of “sueding”—a phenomenon in typical carpet where over time the yarn bundles begin to weaken and bend, resulting in wear on the non-tip surface of the yarn resulting in worn/pulled/broken fibers. These broken fibers give a muted appearance to the carpet which changes to another shade when a hand or vacuum is run over the carpet (hence the term “sueding”). The present invention reduces this problem.

Additionally, the yarn of the present invention enhances any jet dyeing operation due to the nature of the yarn being more erect in the carpet at the dyeing process, hence the dye which is streamed to exact points on the carpet face is more apt to be applied where, and in the quantities, intended.

Other objects of the invention are to enhance the dyeability of carpet, the appearance of the carpet over time, both the color and the patterning detail, and the life of the yarn bundle itself

In at least one embodiment, the present invention addresses the problem of “sueding” in tufted carpet and increases the effective life of the carpet, especially woolen carpet. It also improves the dyeing of the carpet where pattern is applied by jet dyeing and the effective life of the color and pattern detail.

In at least one embodiment, the present invention provides one or more of the following advantages:

1) Extends the effective life of carpet, an advantage for the consumer and an environmental enhancement (less landfill, less recycling.)

2) By being added at the beginning of the product cycle, eliminates the need for elaborate rollers, steaming and the like at pre-dyeing to stand the fiber bundles upright for dyeing.

3) Enables greater detail in dyeing patterns when combined with proprietary dyeing processes such as the Millitron™ jet dye machine.

4) Addresses the “sueding” problem eliminating the need for post installation shearing of carpet to remove broken or loose fibers to return the original appearance to the carpet.

In accordance with at least one embodiment, the present invention allows for the twist lock of multiple yarn plies together, reduces sueding of spun carpets, and allows an insert fiber to be added to yarn on existing equipment and processes.

### BRIEF DESCRIPTION OF THE DRAWINGS

FIG. 1A is a block diagram illustrating, schematically, an exemplary carpet manufacturing process of the present invention.

FIG. 1B is a block diagram illustrating, schematically, a second exemplary carpet manufacturing process of the present invention.

FIG. 2A is a schematic representation of a thread comprising fibers prior to heat set.

FIG. 2B is a schematic representation of a thread comprising fibers after heat set.

FIGS. 3A-B are schematic cross-sectional representations of tufted carpet wherein the fibers are intermingled in FIG. 3A and discrete in FIG. 3B.

FIGS. 3C-D are respective, schematic, top view representations of the tufted carpet of FIGS. 3A-B wherein the tuft heads, are intermingled in FIG. 3C and discrete in FIG. 3D.

FIG. 4 is a block diagram of a first preferred process for preparing fibers of the present invention.

FIG. 5 is a block diagram of another preferred process for preparing fibers of the present invention.

FIG. 6 is a block diagram of yet another preferred process for preparing fibers of the present invention.

FIG. 7 is a block diagram of a substrate pattern dying process and apparatus embodying at least one embodiment of the instant invention.

FIG. 8 is a cross-sectional schematic depiction of a solid shade dyer of a kind that may be used to practice the instant invention.

FIG. 9 is a schematic diagram of a textile patterning device that uses a plurality of computer controlled discrete streams of liquid dye arranged in a series of color-specific arrays that span the path of the moving substrate to be patterned; and, it represents one example of a patterning means useful in the practice of the instant invention.

### DETAILED DESCRIPTION OF THE INVENTION

In accordance with the present invention, a process for manufacturing a carpet that greatly increases manufacturing efficiency and the resolution with which a durable image can be printed or dyed on the carpet has been discovered.

In accordance with at least one preferred embodiment, the present invention is directed to a carpet comprising a composite fiber, thread or yarn printed or dyed in pixelated form. The composite fiber, thread or yarn comprises a low melt fiber and at least one high melt fiber.

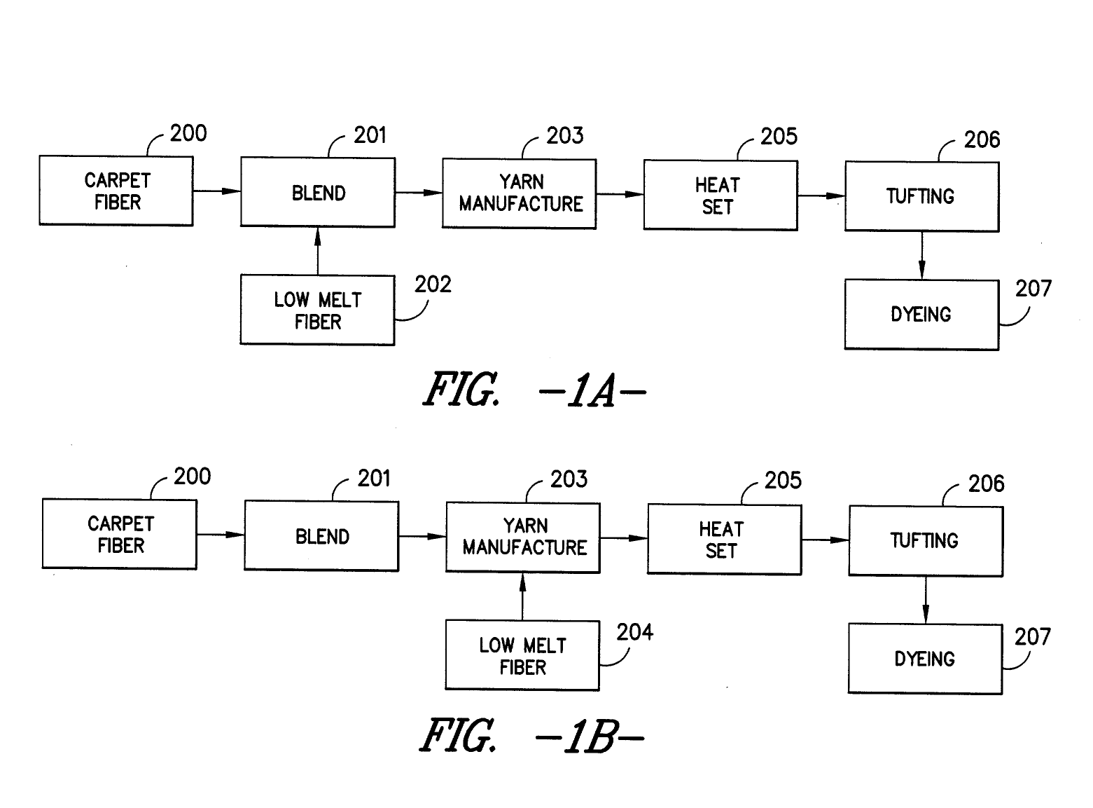

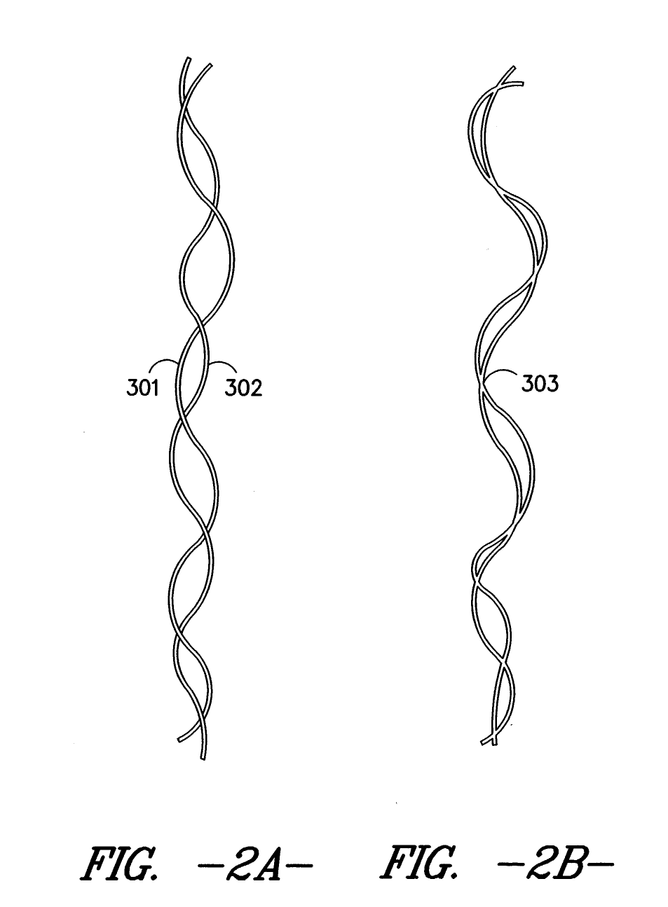

Exemplary processes for manufacturing a tufted carpet will be described with reference to FIGS. 1A and 1B. With reference to FIG. 1A, the primary carpet fiber is initially prepared for use, at 200, as known in the art. The primary carpet fiber is preferably a standard or high melt nylon, wool or a blend of high melt nylon with wool. Although nylon (polyamide, nylon 6 or nylon 6,6) wool, or nylon wool blends (such as a 80/20 nylon/wool blend) are preferred, it is contemplated that any natural or synthetic fiber or filament or blend may be used. The primary fiber is blended with adjuvants or additives as desired, at 201. In one embodiment, illustrated in FIG. 1A, a low melt fiber 202 is incorporated with the primary fiber as a blend at 201. The blended fiber is then manufactured into a thread or yarn, at 203. Alternatively, in a preferred embodiment, a low melt fiber 204 is incorporated with the thread or yarn during the yarn manufacture as indicated at 203 of FIG. 1B.

With reference to FIGS. 1A and 1B, the resultant yarn, comprising at least one primary high melt fiber and at least one secondary low melt fiber, is heat set at 205. The heat set temperature is chosen to be sufficiently high to melt the low melt fiber but not high enough to melt the high melt fiber. For the purposes of the present invention, the preferred low melt fiber has a melting point below about 160° C. and the preferred high melt fiber has a melting point above about 160° C.

Next, the heat set yarn or thread is tufted into a carpet backing as illustrated at 206. The tufted carpet is then printed or dyed, preferably by a pixelated printing system which will be more thoroughly described herein.

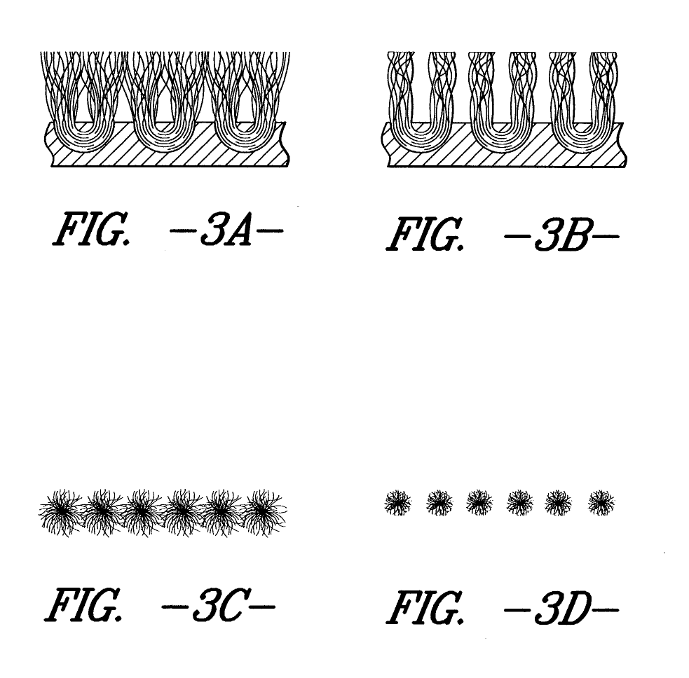

The heat setting or heat fusing of the yarn comprising at least one high or standard melt fiber and at least one low melt fiber is theorized to create tie points between fibers or filaments. The result is a thread or yarn which has less spread, particularly at the end or yarn head, and which can, for example, be used in a higher density in the carpet. A schematic representation of the threads prior to heat set is provided in FIG. 2A and after heat set in FIG. 2B. It is observed that the high melt and low melt fibers, 301 and 302, are independent intermingled fibers prior to heat set but tied together, presumably at tie points, 303, after heat set. The low melt fiber is theorized to at least partially melt and adhere to the high melt fiber or fibers. Upon cooling the adhesive bonds remain.

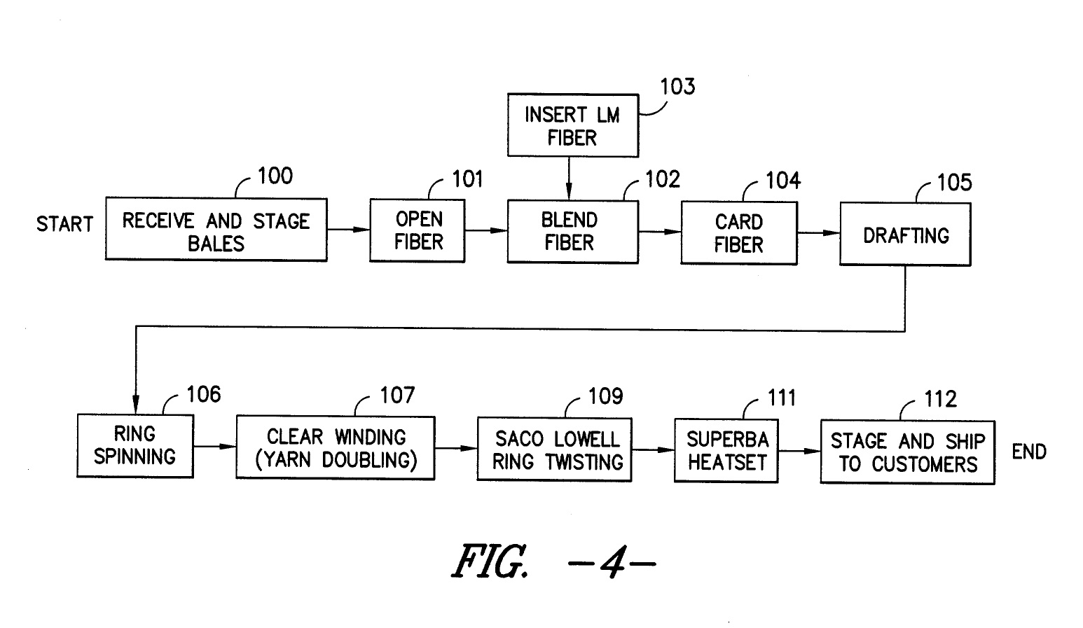

The advantages of heat setting a thread comprising one or more low melt fibers and one or more high melt fibers is illustrated schematically in FIGS. 3A-D. FIG. 3A is a side view representing a cross-sectional cut of a tufted carpet tufted with a conventional yarn without low melt fiber, while FIG. 3B is a similar view representing the tufted carpet of the present invention with yarn with low melt fiber. FIG. 3C is a top view of the yarn of FIG. 3A and FIG. 3D is a top view of the yarn of FIG. 3B. As can be seen, the upper surface of the yarn, or yarn head, is more compact when low melt fiber is incorporated with the high melt fiber followed by heat set. In other words, the yarn bundle is more cohesive, tighter, and more erect. The more compact area allows a finer tufting and print pattern. A diffuse upper surface, as illustrated in FIG. 3C, comprises fibers from adjacent threads or yarns which are intermingled. When a high resolution pattern is printed or dyed thereon, the individual fibers from adjacent yarn will be translationally mobile thereby diffusing the high resolution image. For this reason, the resolution with which carpets could be printed or dyed has been previously limited.

Also, after wear, the conventional tufted carpet of FIGS. 3A and 3C would even be more fuzzed, dispersed, frayed, will have even less resolution, and the like. In contrast, the fused or tacked yarns of the novel printed or dyed carpet of FIGS. 3B and 3D will remain more intact, upright, tighter, have better resolution, and the like after wear or use. Consequently, the carpet of the present invention not only has better color, image, pattern, or design at printing or dyeing, but also looks better after wear or use as compared to conventional carpet.

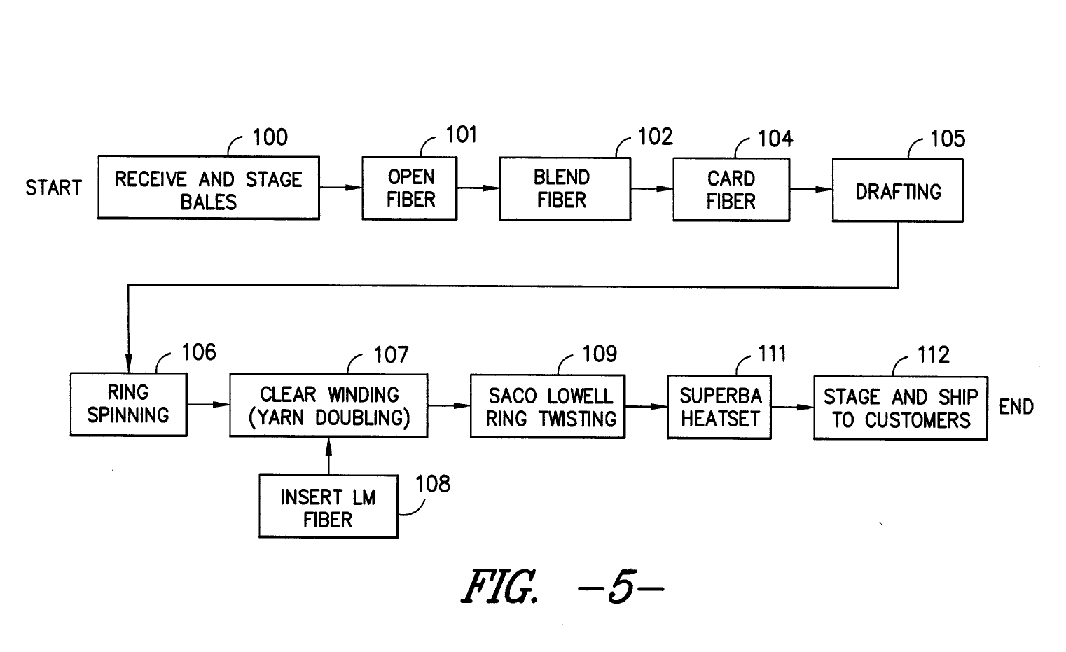

The exemplary process for preparing the fibers, threads or yarns of the present invention will be described in more detail with reference to FIGS. 4-6. In FIGS. 4-6 the primary fiber or fibers, such as standard or high melt nylon 6, nylon 6,6, and/or wool, is typically provided in bales, at 100, as conventional in the art. The fibers are then passed through an opener, at 101, as known in the art. The fiber is optionally blended, at 102, with additives and adjuvants as known in the art. In one embodiment of the present invention, one or more low melt fibers 103 is incorporated with the primary fiber during the blending step, indicated at 102 in FIG. 4. After blending, the fibers or filaments are passed to a carding process, at 104. In the carding process, the non-oriented, interwoven intermingled fibers enter a piked-roller assembly wherein, due to the difference in the longitudinal speed of the rollers the fibers are stepwise oriented and unintermingled longitudinally. This process makes the fibers relatively parallel and orders the fibers longitudinally. After carding, the fibers enter a drafting process, at 105, wherein the fibers are stretched or drawn. The drafting is typically done in three steps commonly referred to in the art as breaker drafting, intermediate drafting and finisher drafting. The stretched fiber then enters a ring spinning operation, at 106, as well known in the art.

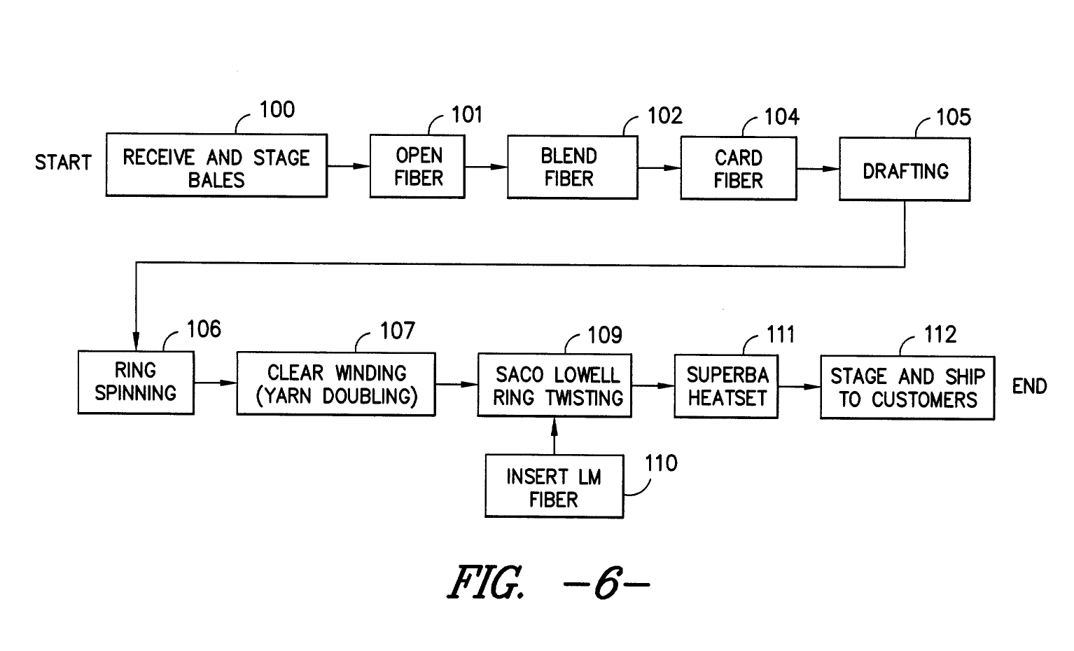

After spinning, the fibers are doubled or wound, at 107, as known in the art. In one potentially preferred embodiment of the present invention, one or more low melt or low melting point fibers (LM) 108, is incorporated with one or more high melt or standard fibers in the doubling operation as indicated at 107 of FIG. 5.

Strands of doubled fiber are combined in a ring twisting operation, at 109. A representative ring twisting operation is available commercially from Saco Lowell as the Rovematic. In a particularly preferred embodiment, one or more low melt fibers (LM) 110, is incorporated with the primary fiber during the ring twisting operation indicated at 109 of FIG. 6.

The resultant fiber is heated, at 111, to a temperature sufficiently high to melt the low melt fiber but not high enough to melt the high or standard melt fiber. A melt temperature of about 60° C. to about 160° C. is preferred. In a particularly preferred embodiment, the fibers are heated to a temperature of less than about 120° C. The low melt fiber is preferably a polyamide. The preferred low melt polyamide is nylon 6 or nylon 6,6. A particularly preferred low melt insert fiber is sold by Solutia, has a size of about 70 Denier, about 17 fibers per cross-section and about 4.1 denier per filament (dpf). The preferred low melt insert fibers are round in shape with a melt point of about 115° C.

The preferred standard or high melt fiber is preferably a high melt nylon, wool or a blend of high melt nylon and wool.

The carpet of the present invention preferably comprises spun fiber selected from a group consisting of nylon, wool, polyester, polypropylene, and blends thereof. More preferably, the spun fiber is selected from nylon and a nylon wool blend. The yarn count range is preferably about 0.5 to about 8.0 per 1 end. Most preferably the yarn count is about 3. The yarn preferably has a twist per inch (TPI) of about 1 to about 10. In single ply yarn, using 100% nylon fibers, about 5.0 twist per inch is preferred. For plied yarn, the twist per inch is preferably about 1 to about 10 with about 4.5 twist per inch being preferred for 100% nylon plied fibers. It is preferred that the denier per filament (dpf) range be about 6 to about 25 dpf with about 19 dpf being most preferred. The yarns may be 1 to 4 ply.

A particularly preferred embodiment comprises the use of a yarn comprising wool, low melt fiber and high melt fiber. The preferred yarn size has a cotton count of about 1.0 to about 5.0 per end with a particularly preferred yarn size having a cotton count of about 2. The yarn preferably has a ply of 1 to 4 with 2 being most preferred. The twist is preferably about 2.5 to 6.5 twist per inch with about 5.5 being preferred. The denier per filament is preferably about 8 to about 28 dpf for nylon, most preferably about 20, and about 25 to about 40 micron for the wool, more preferably about 38 micron.

With reference to FIGS. 4-6, following heat set, the yarn is staged and shipped to customers, indicated at 112, or directly tufted in a carpet backing to form tufted carpet or carpet products, such as tufted face, carpet, broadloom, runners, area rugs, carpet tile, or the like. Carpet tiles are described in U.S. Pat. Nos. 4,522,857, 6,203,881, and 6,468,623 hereby incorporated by reference herein. The yarn of the present invention may be used in tufted or bonded carpet. The carpet may be cut pile, loop pile, or cut and loop pile. It is preferred that it be used in a tufted cut pile carpet that is to be printed or dyed, especially jet dyed by a direct jet or indirect jet dye machine.

As the manufacture of yarn and of carpet from yarn is well known in the art and has been widely practiced for decades, further elaboration and further description herein is not necessary.

The present invention is further directed to a process for forming a carpet comprising pixelated printing or dyeing of color, pattern, design, images, text, and/or the like thereon.

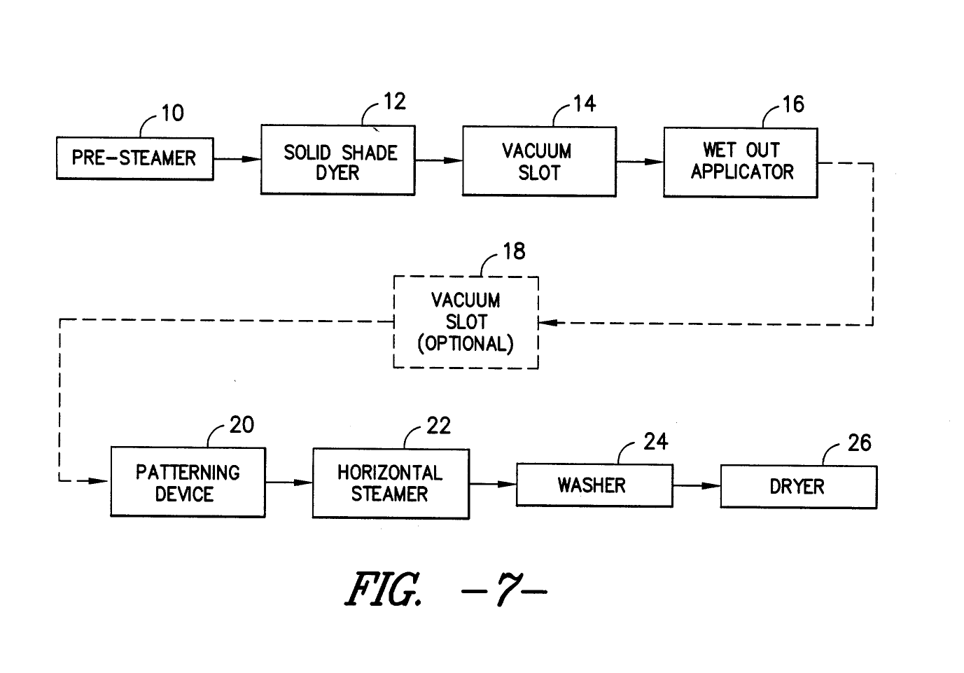

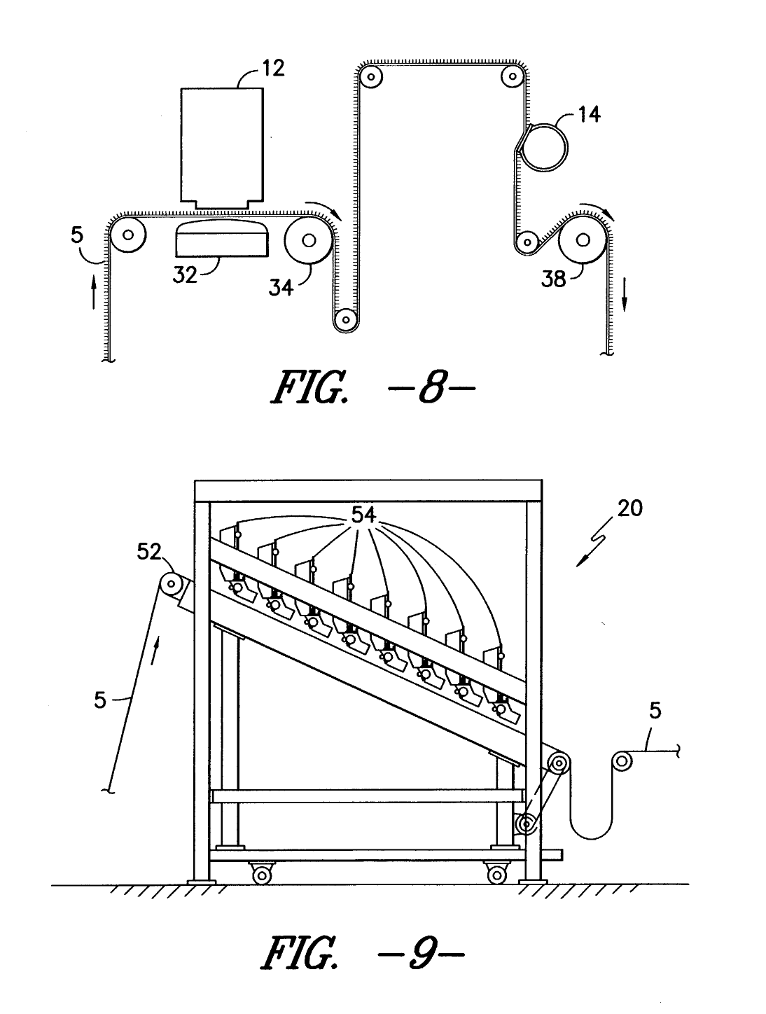

With reference to U.S. Pat. No. 6120,560 and to FIG. 7 of the drawings, one schematic depiction of process steps, sequence or equipment used in one exemplary embodiment of printing or dyeing of the yarn or carpet of this invention is described and shown. A textile substrate to be patterned, 5 of FIGS. 8 and 9, is first subjected to a pre-steamer, depicted at 10, which serves to bulk the yarn in the substrate in preparation for the solid shade dyeing at stage 12. The solid shade dyeing stage depicted at 12 may be carried out using various commercially available devices, so long as the devices are capable of uniformly applying and fixing a dye to a textile substrate in a single step. One way this can be achieved is by heating the dye, and applying uniformly the hot dye to the substrate in a way that allows the hot dye to fix on the substrate with no additional input of energy, as from a subsequent steaming step. For example, the dye may be applied by a series of individual nozzles or applicators that are effectively placed in close proximity to, or in contact with, the surface of the substrate. The nozzles or applicators, in turn, may be surrounded by an enclosure that allows the substrate to pass by or contact the nozzles or applicators. At the same time, the enclosure serves to prevent the dissipation of the thermal energy carried by the heated dye. The result is the dye is sufficiently hot as it contacts the substrate that it fixes almost instantaneously (actually, within a few seconds) after contacting the substrate, with no additional input of energy.

One such arrangement, which is readily available commercially, is schematically depicted in FIG. 8. Here, the substrate web 5 passes between solid shade dyer 12 and a pneumatically actuated pressure pad or bellow 32. This arrangement allows the substrate to contact the dye applicator orifice portion of dyer 12 that is positioned directly opposite bellow 32, and allows the applied heated dye to fix upon contact with the substrate.

An alternative solid shade dyeing arrangement, also using heated dye, is described in detail in U.S. Pat. No. 4,790,043 to Chappell, the disclosure of which is hereby incorporated by reference. It is believed other means or techniques, such as using heated substrates to achieve or enhance dye fixation, would also be satisfactory under appropriate circumstances.

It has been found most effective for subsequent patterning if the color chosen during the solid shade dyeing step is relatively light and relatively neutral. Accordingly, light shades of gray or beige, particularly the latter, are preferred, although other colors and shades may be preferable, depending upon the palette of colors to be used in the patterning step and the overall patterning effect desired.

Although FIGS. 7 and 8 show a solid shade dyeing step, it is to be understood that this step may be eliminated or skiped or that the yarn may be yarn dyed or solution dyed, Beck dyed, or the like. Also, a white or off white yarn (such as natural nylon or bleached wool) may go straight to the wet out application 16 or patterning device 20 and skip any solid shade dyeing or vacuuming.

Following the uniform application and fixing of dye on the substrate in the solid shade dyeing step (if any), the substrate is next passed over a vacuum slot or other means 14 to remove excess moisture, such as water and condensation resulting from the dyeing operation. Following this step, the substrate is prepared for the pattern dyeing step 20 by the application of surfactants and other chemicals 16 useful in achieving deep color penetration and distinct patterns when the patterns are applied to the substrate using highly localized, discrete streams or drops of ambient temperature liquid dye. The exact mix of chemicals at 16 will depend upon a number of factors, including the nature of the substrate, the nature and operating parameters of the patterning device used, the nature and viscosity of the dye, and other factors. The manner in which these chemicals are applied, as depicted at 16, is not critical, so long as the degree of wet pickup is satisfactory and the previously dyed surface is not adversely affected. Depending upon the results of this step, an additional, optional vacuuming stage 18 or the like may be used to remove excess moisture from the substrate prior to patterning.

Following steps 16 and/or 18, the substrate is introduced to a dye jet patterning device 20, such as depicted in FIG. 9. Substrate 5 is passed over roll 52 and onto a conveyer system that allows the substrate to pass before a series of dye applicator arrays 54. Each array is fed from a separate dye supply system, and preferably applies a different color dye. Accordingly, the eight arrays shown would provide for the use of an eight process color palette. It should be remembered, however, that a great many more than eight colors can be generated on the substrate, due to various color mixing and blending techniques. The details of the patterning device are not believed to be critical. Usually, both the substrate, as it passes through patterning device 20 and the dye applied to the substrate in patterning device 20 are essentially at ambient temperature. No effort is made to introduce thermal or other forms of energy into the dyeing process in an effort to fix, either fully or partially, any of the patterning dye until the patterning of the substrate is complete and the substrate leaves patterning device 20.

The patterning device 20 may be a broadloom patterning device as shown in FIG. 9 or a carpet tile patterning device as shown in U.S. Pat. No. 3,894,413 incorporated by reference herein. U.S. Pat. No. 3,894,413 shows a jet dyeing apparatus including a supply table, jet applicator, steam chamber, water washer, hot air dryer, and collection table. Hence, carpet may be dyed in broadloom form, tile form, area rug form, runner form, or the like. Further, carpet may preferably be dyed in broadloom form and then cut into tiles, rugs, runners, area rugs, and/or the like.

Following this patterning operation, the substrate is sent, in turn, to a steamer 22, in which the dyes applied during the patterning step are fixed, then to a washer 24, where excess dyeing chemicals such as those applied at 16 may be removed, and finally to a dryer 26, where the substrate may be dried (see FIG. 7). All of these devices 22, 24, and 26 may be of any appropriate design.

It has been found that postponing the fixing of the patterning dye until the patterning is complete provides an opportunity to create an extremely rich and broad variety of color effects due to the ability to mix and blend different dyes after they have been deposited on the substrate. For example, an area on the substrate carrying unfixed dye from one of the applicator arrays can be the target of a different color dye from another of the applicator arrays, thereby providing for the in situ blending of the two different unfixed dyes. Similarly, the target for the different color dye can be selected near the edge of a previously dyed area, thereby providing for in situ dye diffusion primarily along a boundary between the two unfixed dye areas.

Because the initial solid shade is of a light, neutral color, it lends itself quite well to providing a fixed, aesthetically pleasing background against which the effects of the patterning dyes, singly and in blended combinations, can be displayed, and also appears to contribute visually and aesthetically, if not physically, to the in situ blending of the various patterning dyes on the substrate.

A particular advantage is provided in a process for manufacturing carpet wherein a yarn comprising one or more low melt fibers and one or more high melt fibers is dyed imagewise in a pixelated printing process. The consistency of the yarn head, as described in reference to FIGS. 3B and 3D, greatly decreases the diffusion, or spread, of fibers within the yarn. As a result individual yarn heads can be dyed independently of the adjacent yarn heads. Furthermore, the yarn heads are sufficiently discrete to allow each yarn head to receive multiple pixels of dye. The effective image resolution of the patterned image is much higher than that obtained with prior art yarns. The yarn head of prior art yarns tend to intermingle. As a result of intermingling a single pixel of dye will be received by an individual dye head as well as those fibers from neighbouring yarn heads. As the fibers of the yarn head move the pattern becomes diffuse thereby obscuring any fine print. As a result, the carpet manufacturer has been limited to patterns which are already diffuse and which are not rendered aesthetically unpleasing when further diffused.

The carpet manufacturer has heretofore been limited to two relatively unacceptable methods for creating patterned carpet. Either the yarn is pre-colored and tufted in a pattern or the yarn is printed or dyed, such as dyed in a pixelated fashion by a Millitron™ jet dye machine after tufting. If pre-colored yarn is used the cost of manufacturing increases due to the demand that sufficient inventory of each colored yarn be maintained. Also, image resolution is still less than a single yarn head due to fibers intermingling between yarn heads. If the yarn is dyed after tufting, the resolution is limited due to fibers intermingling. Fibers from adjacent yarn heads are colored or they intermingle after coloring to diffuse the image. Both of these prior situations may be improved by use of the low melt content yarns of the present invention.

A dyed or patterned image is susceptible to wear as is well known in the art. With an image that is designed to be aesthetically pleasing when diffused this is of minimal concern. With a higher resolution pattern, wear is a critical concern. If the high resolution image is diffused by wear, the resolution is lost and therefore the advantages are mitigated. Therefore, one would ordinarily be expected to avoid high resolution images, or images with small pixels, due to the adverse effects of wear. It is a surprising result that a carpet manufactured according to the present invention demonstrates wear resistance, in terms of image retainability, which is superior to prior products as indicated in the following examples.

### EXAMPLE 1

A control carpet (C1) was prepared comprising 100% nylon fibers. The carpet comprised a yarn count of about 3.1, about 4.5 to 5.0 twist per inch and about 19 dpf.

An inventive carpet (I1) was prepared in a manner consisting with control (C1) with the exception of incorporation of a low melt fiber insert. The low melt fiber was inserted during the doubling process. A motion detector, wired to a PLC at the winding frame was incorporated to stop the spindle from doubling yarn whenever lack of movement from the low melt fiber was detected.

The control carpet (C1) and the inventive carpet (I1) were tested visually and with a Hexapod Drum Tester (ASTM D-5252) or Hexapod Tumbler (ISO/TR 10361) for the number of cycles indicated in Table 1. Each test specimen was removed every 2000 cycles for restoration by vacuuming. An electrolux upright vacuum cleaner (Discovery II) was used to make four (4) forward and backward passes along the length of the specimen. The samples were assessed using daylight equivalent vertical lighting (1500 lux). Samples were viewed at an angle of 45 degrees from a 1.5 meter distance, judging from all directions. Ratings were based on CRI TM-101 Photographic Scales with a rating index as follows: 5=negligible or no change; 4=slight change, 3=moderate change, 2=considerable change, 1=severe change. The samples were also measured for pile height before and after testing to obtain a pile height retention value.

TABLE 1

| Cycles | Overall Appearance | | Color Change | | Pile Height | |
|---|---|---|---|---|---|---|
| Retention | C1 | I1 | C1 | I1 | C1 | I1 |
| 4000 | 4 | 4 | 3 | 3 | 82.9% | 80.2% |
| 12000 | 2.5 | 3 | 2 | 2 | 64.7% | 76.1% |

The specimens were visually inspected after 12,000 cycles. The inventive sample (I1) had a sharper image as visualized in a Hapsburg Pattern. The edges of lines were clearly evident in the inventive sample while the line edges were diffuse in the control sample. The yarn head tufts were clearly visible in the inventive sample while those of the control sample were not as readily visible. Color saturation and contrast were retained in the inventive sample. The color saturation and contrast of the control sample (C1) was inferior to the inventive sample (I1) both before and after testing. A visual comparison of the tested samples with untested samples revealed that the color saturation and contrast was depleted in the tested control relative to the untested (no wear) control. The color saturation and contrast remained with minimal depletion in the tested inventive sample relative to the untested (no wear) inventive sample.

### EXAMPLE 2

A control sample (C2) and inventive sample (I2) were prepared and tested as described in Example 1. The results are provided in Table 2.

TABLE 2

| Cycles | Overall Appearance | | Color Change | | Pile Height | |
|---|---|---|---|---|---|---|
| Retention | C2 | I2 | C2 | I2 | C2 | I2 |
| 4000 | 4 | 4.5 | 5 | 4-5 | 91.4% | 94.3% |
| 12000 | 3 | 3.5 | 4 | 4 | 81.7% | 86.2% |

A visual evaluation, and comparison of the tested samples with untested samples, yielded results substantially similar to those recorded relative to Example 1.

In accordance with the present invention, the addition of a “low melt” polyester or nylon (such as manufactured by Solutia) during the yarn manufacturing process (whether all one type of fiber or a blend of multi-types such as wool, nylon, a combination of these or others) results in a yarn after the heat set process that has enhanced end point definition and optical color evenness when put into a carpet base and dyed by a jet dye machine. Both staple and filament low-melts will work but the filament low-melt is preferred.

Even after extended wear tests, the carpet of the present invention shows less evidence of “sueding”—a phenomenon in typical carpet where over time the yarn bundles begin to weaken and bend, resulting in wear on the non-tip surface of the yarn resulting in worn/pulled/broken fibers. These broken fibers give a muted appearance to the carpet which changes to another shade when a hand or vacuum is run over the carpet (hence the term “sueding”). The present invention reduces this problem.

Additionally, yarn of the present invention enhances any jet dyeing operation due to the nature of the yarn being more erect in the carpet at the dyeing process, hence the dye which is streamed to exact points on the carpet face is more apt to be applied where, and in the quantities, intended.

Other objects of the invention are to enhance the dyeability of carpet, the appearance of the carpet over time, both the color and the patterning detail, and the life of the yarn bundle itself.

In at least one embodiment, the present invention addresses the problem of “sueding” in tufted carpet and increases the effective life of the carpet, especially woven carpet. It also improves the dyeing of the carpet where pattern is applied by jet dyeing and the effective life of the color and pattern detail.

In at least one embodiment, the present invention provides one or more of the following advantages:

1) Extends the effective life of carpet, an advantage for the consumer and an environmental enhancement (less landfill, less recycling).

2) By being added at the beginning of the product cycle, eliminates the need for elaborate rollers, steaming and the like at pre-dyeing to stand the fiber bundles upright for dyeing.

3) Enables greater detail in dyeing patterns when combined with proprietary dyeing processes such as the Millitron™ jet dye machine.

4) Addresses the “sueding” problem eliminating the need for post installation shearing of carpet to remove broken or loose fibers to return the original appearance to the carpet.

In accordance with at least one embodiment, the present invention allows for the twist lock of multiple yarn plies together, reduces sueding of spun carpets, and allows an insert fiber to be added to yarn on existing equipment and processes.

In accordance with one example of the present invention, a nylon yarn is replaced with a nylon yarn having a low melt insert. In a more particular example, a two ply nylon yarn is replaced with a two ply nylon yarn including a low melt yarn insert added during the doubling or winding step to form a low melt containing yarn having the low melt dispersed throughout the yarn as contrasted to adding the low melt in spinning or twisting. It is preferred to use a low melt nylon, such as a nylon 6 or nylon 6,6, so that it will dye similarly to the nylon or wool of the nylon yarn, wool yarn, or nylon/wool blend yarn.

In accordance with one example, it is preferred that the low melt fibers, filaments, threads, or yarns, represent less than about 20% by weight of the total yarn, more preferably less than 10%, and most preferably less than 5%.

In a visual inspection of prior patterned carpet and patterned carpet having the low melt content of the present invention, the low melt content carpet has an over all better appearance, better color, brighter color, a little harder hand, tighter yarn heads, defined yarn heads, finer detail, and the like. After wear testing, the low melt content carpet still has better color, better resolution, tighter yarn heads, less visible wear, and the like than a prior patterned carpet subjected to wear.

In accordance with another example, a wool yarn is replaced with a wool yarn having a low melt insert.

In accordance with still yet another example, a wool/nylon blend yarn is replaced with a wool/nylon blend yarn having a low melt insert.

The invention has been described with particular emphasis on the preferred embodiments. It would be realized from the teachings herein that other embodiments, alterations, and configurations could be employed without departing from the scope of the invention which is more specifically set forth in the claims which are appended hereto.

Claimed is:

1. A carpet prepared by the process of:
forming a thread comprising at least one low melt fiber and at least one high melt fiber;
heating said thread above a temperature sufficient to melt said low melt fiber;
tufting said thread in a carpet backing to form a tufted carpet; and
printing an image on said tufted carpet.

2. The carpet of claim 1 wherein said low melt fiber is incorporated in said thread during blending.

3. The carpet of claim 1 wherein said low melt fiber is incorporated in said thread during doubling.

4. The carpet of claim 1 wherein said low melt fiber is incorporated in said thread during twisting.

5. The carpet of claim 1 wherein said low melt fiber is incorporated in said thread during spinning.

6. The carpet of claim 1 wherein said thread is heated to a temperature of about 60° C. to about 160° C.

7. The carpet of claim 6 wherein said temperature is no more than about 120° C.

8. The carpet of claim 1 wherein said low melt fiber comprises polyamide.

9. The carpet of claim 7 wherein said polyamide is selected from a group consisting of nylon 6,6 and nylon 6.

10. The carpet of claim 1 wherein said high melt fiber comprises one material selected from the group consisting of nylon, wool, polyester, polypropylene, and blends thereof.

11. The carpet of claim 1 wherein said printing is carried out by a jet dye machine in a pixelate fashion.

12. The carpet of claim 1 wherein said high melt fiber is at least one of nylon and wool.

13. The carpet of claim 1 wherein said high melt fiber is a nylon wool blend.

14. The carpet of claim 1 wherein said thread has a cotton count of about 1.0 to about 5.0.

15. The carpet of claim 1 wherein said thread has a cotton count of about 2.

16. The carpet of claim 12 comprising about 8 to about 28 denier per filament for nylon.

17. The carpet of claim 12 wherein said wool is about 25 to about 40 microns.

18. The carpet of claim 12 wherein said wool is about 38 microns.

19. The carpet of claim 1 wherein said thread has a yarn count of about 0.5 to about 8.0.

20. The carpet of claim 19 wherein said yarn count is about 3.

21. The carpet of claim 1 wherein said thread has about 1 to about 10 twist per inch.

22. The carpet of claim 21 wherein said thread has about 5 twist per inch.

23. The carpet of claim 22 wherein said thread is a 1 to 4 ply.

24. The carpet of claim 21 wherein said thread is plied nylon with about 4.5 twist per inch.

25. The carpet of claim 1 wherein said thread has about 6-25 denier per filament.

26. The carpet of claim 25 wherein said thread has about 19 denier per filament.

27. The carpet of claim 25 wherein said thread has 1 to 4 ply not including said low melt.

28. The carpet of claim 27 wherein said thread has 2 ply.

29. A process for forming printed carpet comprising the steps of:
forming a thread comprising low melt fiber and high melt fiber;
heating said thread above a temperature sufficient to melt said low melt fiber;
tufting said thread in a carpet backing to form a tufted carpet; and
printing an image on said tufted carpet.

30. A carpet prepared by the process of:
forming a blended fiber comprising a low melt fiber and a high melt fiber;
forming a thread of said blended fiber;
heating said thread above a temperature sufficient to melt said low melt fiber;
tufting said thread in a carpet backing to form a tufted carpet; and
printing an image on said tufted carpet.

31. A carpet prepared by the process of:
forming a thread from a high melt fiber;
passing said thread through a doubling or winding process wherein a low melt fiber or thread is added; spinning to form a combined thread or yarn;
heating said combined thread above a temperature sufficient to melt said low melt fiber;
tufting said heated thread in a carpet backing to form a tufted carpet; and
printing an image on said tufted carpet.

32. A carpet prepared by the process of:
forming a fiber blend from a high melt fiber;
passing said fiber blend through a ring spinning process wherein a low melt fiber is added to said fiber blend to form a combined thread;
heating said combined thread above a temperature sufficient to melt said low melt fiber;
tufting said heated thread in a carpet backing to form a tufted carpet; and
printing an image on said tufted carpet.

33. A process for forming jet dyed patterned carpet comprising the steps of:
forming a blended fiber comprising a low melt fiber and a high melt fiber;
forming a thread of said blended fiber;
heating said thread above a temperature sufficient to melt said low melt fiber;
tufting said thread in a carpet backing to form a tufted carpet; and
printing an image on said tufted carpet using a jet dye machine.

34. In a patterned carpet, the improvement comprising:
a carpet yarn having a low melt content and having been heated sufficiently to melt at least a portion of the low melt content prior to patterning.
